(19) United States
(12) Patent Application Publication
(10) Pub. No.: US 2007/0280236 A1
(43) Pub. Date: Dec. 6, 2007

(54) SYSTEM AND METHOD FOR PROVIDING MULTICAST SERVICE

(75) Inventor: Zhenting YANG, Shenzhen (CN)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: HUAWEI TECHNOLOGIES CO., LTD., Shenzhen (CN)

(21) Appl. No.: 11/753,117

(22) Filed: May 24, 2007

(30) Foreign Application Priority Data
Jun. 1, 2006 (CN) 200610083829.8

(51) Int. Cl. H04L 12/56

(52) U.S. Cl. 370/390; 370/432

(57) ABSTRACT

A system and a method for performing a multicast service are disclosed. In accordance with embodiments of the present invention, an Application Layer Gateway Subsystem set in the network side handles application layer protocol messages communicated between the network side and a UE, and triggers, according to a handling result of the application layer protocol messages, a Multicast Carrier Management Subsystem set in the network side to configure and manage multicast paths in the bearer network, including establishing and deleting the multicast paths. In accordance with the embodiments of the present invention, because the application layer protocol and the multicast management protocol are combined with each other effectively, it is convenient to manage a multicast network, provide an operator with flexible operation management through the application layer protocol, and the security of the multicast service may be guaranteed.

This application claims priority to Chinese Patent Application No. 200610083829.8, filed Jun. 1, 2006, which is hereby incorporated by reference.

### FIELD OF THE TECHNOLOGY

The present invention relates to network communication technologies, and particularly, to a system and a method for providing a multicast service.

### BACKGROUND OF THE INVENTION

Along with the fast development of communication technologies, communication methods for transferring services using multicast technologies are proposed to reduce burdens on the bandwidth of a transport network. The terminology Multicast means that a transmitter sends the same service contents to multiple receivers simultaneously. Since the same contents may be sent to designated multicast addresses, burdens on the transmitter of the service and the transport network may be reduced and the network resource may be used efficiently. The multicast technologies have provided fast and effective solutions for developing multimedia services, such as the Internet Protocol Television (IPTV).

In order to acquire multicast contents corresponding to a multicast service, a user, as a receiver of multicast contents, needs to require, by joining a multicast group of the multicast service, a neighbouring router to send the multicast contents corresponding to the multicast service to the user. For example, the user may join the multicast group using the Internet Group Management Protocol (IGMP) or the Multicast Listener Discovery (MLD) protocol. Moreover, a router providing the multicast service needs to interact with other routers using a multicast route protocol, such as the Protocol Independent Multicast-Sparse Mode (PIM-SM) protocol, so as to establish multicast paths. Thus, multicast contents may be transferred from a multicast source to receivers of multicast contents along the multicast paths.

The IGMP or the MLD protocol is an important protocol that may be used in the process of providing a multicast service, which is a part of the Internet Protocol (IP). The IGMP or the MLD protocol is run between hosts and routers and used for implementing multicast membership management and discovery. The IGMP or the MLD protocol enables a router and a host to inform each other of the state information of a user of a multicast service, for example, dynamically joining or quitting a multicast group; and the IGMP or the MLD protocol needs to enable the router to announce a change of the members of the multicast group in a multicast network through a route protocol so as to update corresponding multicast route information.

The IGMP or the MLD protocol implements the functions as follows:

(1) a host informs, through the IGMP or the MLD protocol, local routers that the host hopes to join a specified multicast group and receive information of the specified multicast group;

(2) a router periodically queries, through the IGMP or the MLD protocol, whether members of a multicast group in a Local Area Network are in an active state, that is, whether there is a member belonging to the multicast group in this network segment, in other words, the router needs to record information about whether there is a local member of the multicast group so as to collect and maintain relations between the members of the multicast group in the network to which the router is connected, and thus it is convenient for the router to control the issue of contents of a multicast service based on the recorded information.

In order to acquire multicast contents of the multicast service, a multicast service user, as a content receiver, must join a multicast group of the multicast service on his own initiative, and after receiving a request, the multicast bearer network updates routes recorded in the router through a route protocol, and establishes and maintains multicast paths dynamically so as to implement the multicast service according to the multicast paths.

The management of a multicast service is mainly divided into two processes based on protocols adopted in the process of performing the multicast service. Specifically, the two processes include the management process of a service application layer, which is to be performed first, and the management process of a multicast transport protocol layer, which is to be performed later.

The management process of the service application layer means service management interaction between a user and an application server of the multicast service, such as service start requesting, service termination requesting, and service Keep Alive handling; and in the management process of the service application layer, information interaction is generally performed by using an application layer protocol, such as the Hypertext Transfer Protocol (HTTP), the Session Initiation Protocol (SIP), the Real-Time Stream Protocol (RTSP), or the Remote Desktop Protocol (RDP).

The management process of a multicast transport protocol layer means a process in which a host or a UE and a neighbouring router inform each other. Specifically, when requesting starting a multicast service, the host or the UE needs to inform the neighbouring router that the host or the UE hopes to join a multicast group, and the neighbouring router establishes a multicast group member relation table and updates a multicast forwarding table according to a joining message; when requesting terminating a service, the host or the UE needs to inform the neighbouring router that the host or the UE hopes to leave a multicast group, and the neighbouring router deletes the designated multicast group member relation table and updates the multicast forwarding table to stop forwarding the multicast stream to the host or the UE according to a leaving message.

The management of a multicast service is mainly divided into two basic processes, that is, a multicast service start process and a multicast service termination process, based on the specific handling in the process of performing the multicast service. Moreover, in the two basic processes, the corresponding management process of the service application layer may not need to be implemented, but the corresponding management process of the multicast transport protocol layer must be implemented.

The multicast service start process, that is, the process of applying for a multicast service by a user, is hereinafter described first. As shown in FIG. 1, an existing process of applying for a multicast service specifically includes the following steps.

Step 11: a user applies to an application server for a designated multicast service.

Step 12: the application server acknowledges the application of the user after handling the application of the user.

Step 13: the user initiates a multicast group member joining request, IGMP JOIN message, for joining a designated multicast group after receiving the acknowledgement of the application from the application server.

Step 14: an Access Node (AN) connected to the user forwards the multicast group member joining request upon receiving the multicast group member joining request, if there is not a multicast group, which the user requests joining, in the AN.

Specifically, the AN receives the multicast group member joining request from the user through an IGMP proxy function or an IGMP SNOOPING function, handles the multicast group member joining request of the user, configures multicast paths, and updates a multicast group member relation table after the success of the handling of the multicast group member joining request of the user; if there is not a multicast group, which the user requests joining, in the AN, that is, the user is the first user in the AN to join the multicast group, the AN continues to forward the multicast group member joining request from the user.

Step 15: after the multicast group member joining request from the user is handled and transferred to an IP EDGE level by level, that is, after receiving the IGMP JOIN message for joining the designated multicast group, the IP EDGE configures the multicast paths, updates the multicast group member relation table and continues to forward the multicast group member joining request.

Step 16: the multicast group member joining request from the user is forwarded level by level, and is finally transferred to the multicast source, that is, the application server, and then multicast stream data begin to be transferred.

An existing multicast service termination process, that is, the process of requesting the termination of a multicast service by a user, is hereinafter described. As shown in FIG. 2, the existing multicast service termination process specifically includes the following steps.

Step 21: the user requests an application server to terminate a designated multicast service.

Step 22: the application service acknowledges the termination request from the user after handling the termination request of the user.

Step 23: the user sends a multicast group member leaving request.

Step 24: after receiving the multicast group member leaving request from the user, the AG deletes multicast paths, updates a multicast group member relation table, and continues to forward the multicast group member leaving request if the user is the last member of the multicast group in the AN.

Step 25: the multicast group member leaving request from the user is handled and transferred to an IP EDGE level by level, and the IP EDGE handles the request using the same principle as that in the AN so as to terminate the multicast service of the user.

The inventors of the present application, in the design of the present invention, discovered the following issues.

There are two protocol management processes in a multicast service process, that is, the management process of a service application layer and the management process of a multicast transport protocol layer, and the two management processes are not combined with each other effectively, which results in a difficult management of the network in practice.

Specifically, in the process of performing a multicast service, corresponding multicast protocol management processes between a host or a UE and a service operator network must be implemented, however, since the management process of the service application layer is transparent to the network layer while the management process of the multicast transport protocol layer runs in the network layer, the two management processes cannot be combined effectively, that is, it is difficult to meet the demands for operability and manageability of telecommunication.

The existing multicast management protocols, such as the IGMP and the MLD protocol, can not provide a guarantee of security, and thus there are large potential threats to the security of a multicast service.

For example, in the existing multicast management protocols, such as the IGMP and the MLD protocol, there is no interaction mechanism with request and response (for example, there is no corresponding request and response mechanism in the process of requesting joining a multicast group by a user); as a result, it is difficult to authenticate a user which requests joining a multicast group, and it is not favourable for managing the user in the process of performing a multicast service, and thus it is difficult to provide good experience for the user of the multicast service.

### SUMMARY OF THE INVENTION

Embodiments of the present invention provide a system and a method for providing a multicast service so as to make it convenient to manage the multicast service flexibly and improve the security of the multicast service.

A system for providing a multicast service includes:

a User Equipment (UE);

an application server (AS), for providing the UE with the multicast service;

an Application Layer Gateway Subsystem (ALGSS), for handling an application layer protocol message communicated between the network side and the UE;

a Multicast Carrier Management Subsystem (MCMSS) provided at the network side, for configuring and managing, under a triggering of the ALGSS, multicast paths through which the multicast service issued by the AS is transferred to the UE.

The system further includes:

a service subscription management entity communicated with the ALGSS, for managing service subscription data, authorizing, according to the service subscription data, the multicast service of the UE requesting joining a multicast group under a triggering of the ALGSS, and informing the ALGSS of information that the authorization of the multicast service of the UE is passed; and the ALGSS triggers the MCMSS after the authorization of the multicast service of the UE by the service subscription management entity is passed.

The system further includes:

an authentication, authorization, and/or accounting server communicated with the ALGSS, for performing at least one of access authentication, access authorization and service charging of the UE accessing to the network.

The ALGSS further communicates with the application server, and instructs the application server to issue or stop the multicast service.

The ALGSS includes:

at least one application layer gateway functionality set in an access node device or at the network side, for cooperating with each other to handle the application layer protocol message communicated between the network side and the UE.

The MCMSS includes:

at least one multicast transport management functionality set in at least one network device or at the network side, for configuring and managing the multicast paths.

The ALGSS is further used for managing the state of the multicast service between the ALGSS and the UE by means of a Keep Alive mechanism.

An application layer gateway functionality includes:

a multicast service handling unit, for handling an application layer protocol message communicated between the network side and a User Equipment (UE) in a process of performing a multicast service; and

a multicast service triggering unit, for triggering the configuration and management of multicast paths according to a result of the handling of the application layer protocol message.

The application layer gateway functionality further includes:

a service query unit, for sending to the UE a service state query request for monitoring whether the UE is online;

a query timer, for managing the service query unit to periodically perform message interaction with the UE for monitoring whether the UE is online.

a query wait timer, for determining that the UE is offline when the query wait timer expires, and triggering multicast group termination handling and UE offline handling; and

the query wait timer is started when the application layer gateway functionality sends to the UE a message for monitoring whether the UE is online;

the query wait timer is stopped when the application layer gateway functionality receives a response message returned by the UE.

A multicast transport management functionality includes:

a topology management unit, for managing information of network topology; and

a path configuration and management unit, for configuring and managing multicast paths, according to the information of network topology, under a triggering of an application layer gateway functionality which handles an application layer protocol message communicated between the network side and a User Equipment (UE).

The multicast transport management functionality further includes:

a protocol conversion unit, for converting a protocol sent by the application layer gateway functionality into a multicast management protocol.

A method for providing a multicast service includes:

sending, by a User Equipment (UE), to an Application Layer Gateway Subsystem (ALGSS) an application layer protocol message for providing the multicast service;

triggering, by the ALGSS, upon receiving the application layer protocol message, a Multicast Carrier Management Subsystem (MCMSS) to configure and manage multicast paths.

The application layer protocol message includes: a Session Initiation Protocol (SIP) message, a Real-Time Stream Protocol (RTSP) message, a Hypertext Transfer Protocol (HTTP) message and a Remote Desktop Protocol (RDP) message.

The method further includes:

instructing, by the ALGSS, based on a configured policy, an application server of the multicast service to issue or stop the multicast service.

The method further includes:

authorizing, by a service subscription data management entity, the multicast service of the UE requesting joining a multicast group under a triggering of the ALGSS.

The method further includes:

performing, by an authentication, authorization and/or accounting server, at least one of access authentication, access authorization and service charging of the UE accessing the network.

The application layer protocol message includes a multicast service request/termination message of application layer; and

the triggering the MCMSS to configure and manage the multicast paths includes:

instructing the MCMSS to configure and manage or delete the multicast paths.

The method further includes:

converting, by the MCMSS, an instruction received from the ALGSS into a multicast management protocol message.

The method further includes:

periodically performing, by the ALGSS, message interaction with the UE, and monitoring, according to a result of the message interaction, whether the UE is online.

The configuring and managing the multicast paths further includes:

handling a Connection Admission Control (CAC) of the multicast paths; and

managing an allocation and callback of network resources; and

the CAC is used for determining whether remaining resources in the bearer network meet demands of the Quality of Service (QoS) of the multicast paths to be established.

As can be seen from the above technical solutions in accordance with the embodiments of the present invention, in the process of performing a multicast service, an application layer protocol and a multicast management protocol is combined with each other effectively, and thus, it is made convenient to manage a multicast network, that is, an operator may provide flexible operation management through the application layer protocol.

Moreover, the security of the multicast service may be improved greatly since the interaction between a UE and the network side is performed through an application layer protocol in the process of performing a multicast service; and it is also made convenient and fast to authenticate a user requesting joining the multicast service and charge the user for the multicast service, and thus it is favourable for managing the user of the multicast service and further providing good experience for the user of the multicast service.

### BRIEF DESCRIPTION OF THE DRAWINGS

FIG. 1 shows a schematic flow chart illustrating the process of applying for a multicast service in the prior art.

FIG. 2 shows a schematic flow chart illustrating the process of terminating a multicast service in the prior art.

FIG. 3 shows a schematic diagram illustrating the structure of a system of implementing a multicast service in accordance with an embodiment of the present invention.

FIG. 4 shows a schematic flow chart illustrating the process of applying for a multicast service in accordance with an embodiment of the present invention.

FIG. 5 shows a schematic flow chart illustrating the process of terminating a multicast service in accordance with an embodiment of the present invention.

FIG. 6 shows a schematic flow chart illustrating a Keep Alive process of a multicast service in accordance with an embodiment of the present invention.

FIG. 7 shows a schematic flow chart illustrating the process of applying for a multicast service in accordance with an embodiment of the present invention.

FIG. 8 shows a schematic flow chart illustrating the process of terminating a multicast service in accordance with an embodiment of the present invention.

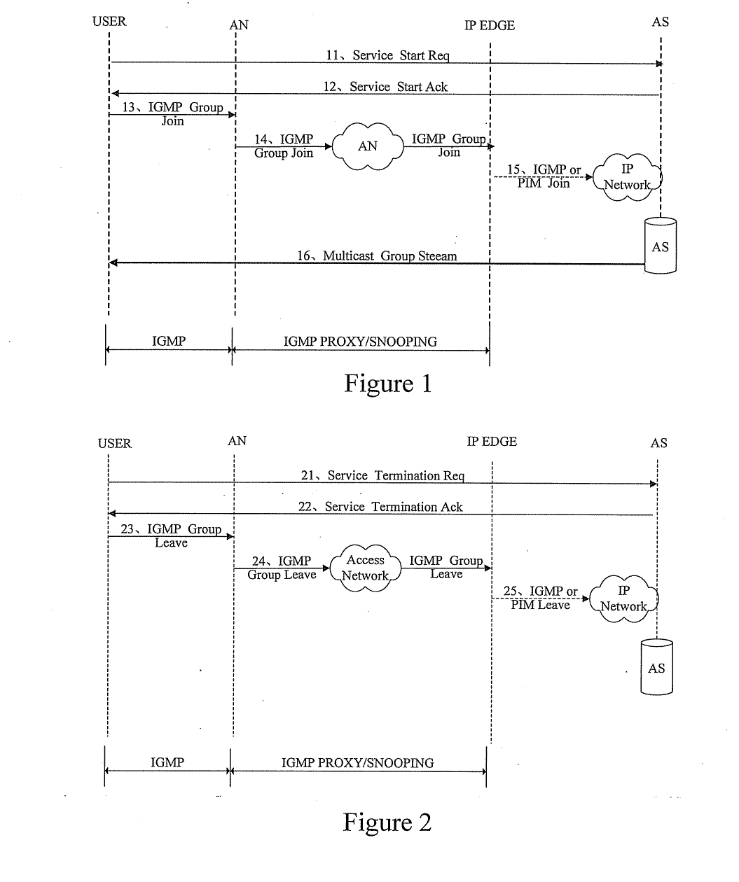

### EMBODIMENTS OF THE INVENTION

In accordance with embodiments of the present invention, an Application Layer Gateway Subsystem (ALGSS) and a Multicast Carrier Management Subsystem (MCMSS) is introduced into an access network, and based on the ALGSS and the MCMSS, the interaction between a user and an access node (AN) connecting the user may be directly performed by using an application layer protocol, such as the SIP or the HTTP, without using the IGMP. Thus, a request and response mechanism is introduced into the process of providing a multicast service so as to improve the experience of a user of the multicast service and improve the network security. Moreover, an operator may provide flexible operation management through the application layer protocol.

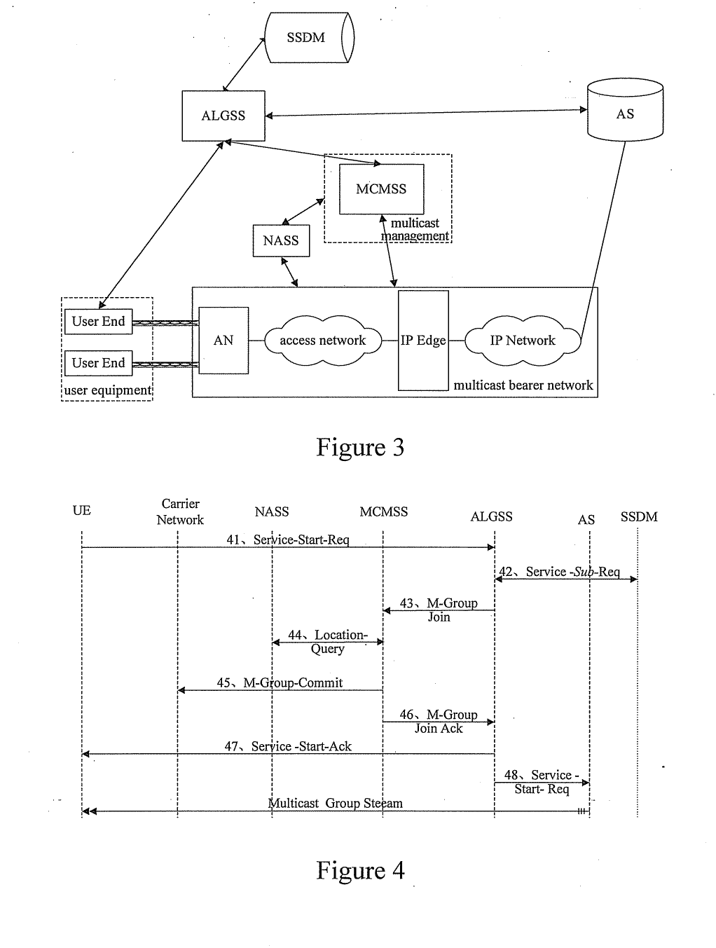

The structure of a system in accordance with an embodiment of the present invention is shown in FIG. 3, and the system includes: a Service Subscription Data Management entity, an ALGSS, an MCMSS, and a Network Attachment Subsystem (NASS).

(1) The Service Subscription Data Management entity is used for managing service subscription data, such as the subscription service data of a user, so as to perform operations, such as authorization of the multicast service request from the user, according to the data.

(2) The ALGSS is used for handling an application layer protocol message, including: a multicast service handling unit, for handling an application layer protocol message communicated between the network side and a UE, for example, extracting a multicast address from the application layer protocol message and inserting the multicast address into the message for triggering a multicast service; and a multicast service triggering unit, for triggering an MCMSS according to a result of the handling of the application layer protocol message to configure and manage multicast paths. The ALGSS further includes a protocol conversion handling unit and a service routing handling unit. The protocol conversion handling unit is used for converting an application layer protocol message into a protocol message supported by an entity that does not support the application layer protocol when the ALGSS communicates with the entity; and the service routing handling unit is used for determining addresses of other entities when the ALGSS communicates with other entities respectively.

Specifically, the ALGSS is mainly in charge of managing and handling multicast service requests (including a multicast service application request and a multicast service termination request) from a user, and controlling the multicast paths of a multicast stream using different policies (in the case that there are multiple multicast paths), so as to implement the operability and manageability of multicast service.

The ALGSS is further used for performing authorization of a multicast service request, such as a multicast service application request or a multicast service termination request, sent by the user, and communicating, after the authorization is passed, with the MCMSS so as to perform the subsequent handling of the multicast service; the authorization may be performed locally in the ALGSS, or be performed in other entities (e.g., an SSDM).

The ALGSS also communicates with an authentication, authorization and/or accounting server and is used for performing the access authentication, access authorization and/or corresponding service charging of a UE accessing a network.

The ALGSS is a logical function subsystem, and specifically, may be composed of one or more Application Layer Gateway Functionalities (ALGFs). The ALGSS includes one single ALGF physical apparatus or device, or multiple ALGF physical apparatuses or devices used for cooperating with each other to handle the application layer protocol message communicated between the network side and a UE in the process of performing the multicast service. In the case that the ALGSS includes multiple ALGFs, addressing may be performed by means of addressing methods, such as proxy and redirection, between the corresponding ALGFs.

The ALGF may be integrated into (embedded in) an Access Node (AN), that is, an AN may implement the corresponding functions of the ALGF; or the ALGF may also be a separate physical apparatus or device; or the ALGF may also be composed of multiple apparatuses or devices.

The ALGSS in the system in accordance with an embodiment of the present invention also includes a Keep Alive handling unit used for managing the state of the multicast service between the ALGSS and a UE in the process of performing the multicast service by the UE.

The Keep Alive handling unit includes a query timer and a service query unit;

the query timer is used for managing the service query unit to periodically perform message interaction with the UE for monitoring whether the UE is online;

the service query unit is, when triggered by the query timer, used for periodically sending to the UE a service state query request for monitoring whether the UE is online.

The ALGSS in the system in accordance with another embodiment of the present invention also includes a query wait timer which is started when the ALGSS sends to a UE a message for monitoring whether the UE is online and is stopped when the ALGSS receives a response message returned by the UE. When the query wait timer expires, the ALGSS determines that the UE is offline and triggers a UE offline process. The UE offline process includes: instructing the MCMSS to perform a multicast group termination process and instructing the ALGSS to perform a UE offline process.

(3) The MCMSS is used for controlling and managing multicast paths in a bearer network, Quality of Service (QoS), topology and/or policies, and specifically, mainly for configuring and managing the multicast paths, including operations, such as configuring the multicast paths or deleting the multicast paths, under the triggering of the ALGSS.

Specifically, the MCMSS is used for handling a multicast management protocol message sent by the ALGSS, such as an IGMP message, so as to implement the corresponding handling, such as the handling of joining or leaving a multicast group. The MCMSS also needs to convert a message sent by the ALGSS into a multicast management protocol message, if the message is not the multicast management protocol message.

The MCMSS is a logical function subsystem, and specifically, may be composed of one or more Multicast Carrier Management Functionalities (MCMFs), that is, one or more MCMFs may compose an MCMSS, and addressing may be performed by using addressing methods, such as proxy and redirection, between the MCMFs so as to implement the communication between the MCMFs.

The MCMF may be integrated into (embedded in) Network Equipment (NE), that is, the NE may implement the functions of the MCMF, or the MCMF may also be a separate physical apparatus or device, or the MCMF may also be composed of multiple apparatuses or devices.

The MCMSS in the system in accordance with an embodiment of the present invention also includes:

a topology management unit for managing topology information of a network, such as information of network resources and link resources, so as to provide the topology information for configuring and managing multicast paths;

a path configuration and management unit for configuring and managing multicast paths in the process of performing the multicast service according to the topology information, that is, configuring and managing a multicast forwarding table of a network element in a bearer network, and configuring and managing the QoS of multicast paths; the process of configuring and managing of the QoS of multicast paths also includes managing the CAC of the multicast paths, and managing allocation and callback of network resources; the CAC is used for determining whether the remaining resources in the bearer network meet the demand of the QoS of the multicast path to be established.

The MCMSS in the system in accordance with the embodiment of the present invention also includes a protocol conversion unit for converting a protocol sent by the ALGSS into a multicast management protocol of the bearer network, which includes the IGMP or the MLD protocol.

(4) The NASS is used for providing access registration of a UE, and specifically, for providing an identification of network level, managing the IP address of a user and authorizing the access of the user. The NASS provides a query of the location of the user for the outside through a standard interface, such as the AN where the user is located and the links inside the AN; the links include physical links and logical links. The MCMSS in accordance with the embodiment of the present invention may acquire the location of the user from the NASS so as to configure a multicast path according to the location of the user, that is, to determine a path through which the multicast service is transferred to the user.

In accordance with an embodiment of the present invention, in the process of managing a multicast service using an application layer protocol by an ALGSS and an MCMSS, the ALGSS and the MCMSS manage multicast group members according to the application layer protocol, and the corresponding management mainly includes the management of multicast group member joining request, the management of multicast group member leaving request, and the management of multicast group member state and multicast paths. Moreover, an operator may also manage the authorization, authentication and accounting of a multicast service in the process of managing the multicast service by the ALGSS and the MCMSS.

The implementation of the management of multicast group member joining request, the management of multicast group member leaving request, and the management of multicast group member state provided by the embodiments of the present invention are hereinafter described in detail with reference to the drawings.

A schematic flow chart illustrating the process of applying for a multicast service in accordance with an embodiment of the present invention is shown in FIG. 4 and specifically includes the steps as follows.

Step 41: a User Equipment (UE), that is, a user, sends a service start request (Service-Start-Req), that is, a multicast service application, to the ALGSS through a bearer network, so as to apply to the network side for a designated multicast service.

An application layer protocol with a request and response mechanism is adopted in this step, such as the SIP, HTTP, RDP or RTSP.

Step 42: after receiving the multicast service application from the user, the ALGSS initiates operations, such as authentication and authorization for the user, for example, the authentication of the multicast service application from the user.

Specifically, after receiving the Service-Start-Req message, the ALGSS handles the multicast service application from the user, that is, first performs a local handling of the multicast service application according to policies configured locally, for example, the management and control of message congestion, and then handles the multicast service application according to the policies configured, for example, performs remote authorization. In the remote authorization, an authorization system may be selected according to a practical policy, for example, an authorization is performed in an SSDM authorization system or in an AS authorization system.

Step 43: the ALGSS instructs the MCMSS to handle a multicast group joining request after the handling of the multicast service application by the ALGSS, for example, after the corresponding authentication and authorization is passed.

For example, the ALGSS may send a multicast group joining request (IGMP Group Join) message to the MCMSS to enable the corresponding user to join the corresponding multicast group.

It should be noted that in Steps 42 and 43, the ALGSS needs to perform the corresponding protocol conversion of a message and send the converted message to an AS or an SSDM, if the protocol adopted by the ALGSS is different from that adopted by the AS or the SSDM.

Step 44: the MCMSS acquires and handles the location information of the corresponding user after receiving the multicast group joining request from the ALGSS.

In this step, there may be many methods with which the MCMSS acquires the location information of the user applying for the multicast service, for example, acquires the location information with the method of configuring the location information locally or communicating with the NASS. In FIG. 4, the location information of the user applying for the multicast service is acquired through the NASS.

Step 45: the MCMSS configures a multicast path in the bearer network after acquiring the location information of the user.

Specifically, the MCMSS first performs the calculation of the multicast path and the corresponding operations, such as Connection Admission Control (CAS), backup and protection path handling, according to network topology and a multicast group member relation table, configures multicast paths of multicast network in the multicast forwarding table of network elements of multicast network, and after the configuration is finished, updates the multicast group member relation table, that is, adds the user to the corresponding multicast group.

The network topology and the multicast group member relation table need to be recorded in the MCMSS, and there are many methods for acquiring MCMSS network topology, for example, acquiring the MCMSS network topology through the General Multiple Protocol Label Switching (GMPLS) Link Management Protocol (LMP), or configuring the MCMSS network topology manually; the multicast group member relation table is generated and managed by the MCMSS itself according to the MCMSS network topology; there are also many methods for calculating the multicast paths, for example, calculating the multicast paths through the GMPLS protocol.

Step 46: the MCMSS responds to the ALGSS with a multicast group joining acknowledgement after handling the multicast group joining request, and the contents of the multicast group joining acknowledgement include results of operations (for example, success or failure of joining) and the number of multicast group members.

Step 47: the ALGSS responds to the UE with an application acknowledgement after receiving the multicast group joining acknowledgement responded by the MCMSS, and starts the Keep Alive mechanism of the multicast service if the multicast service application succeeds.

Step 48: the ALGSS sends a service issuing application request to the AS according to the local policies (for example, authentication and accounting related policies) and the number of multicast group members (for example, there has been at least one multicast member in the multicast group). This step is not necessary, in other words, is optional.

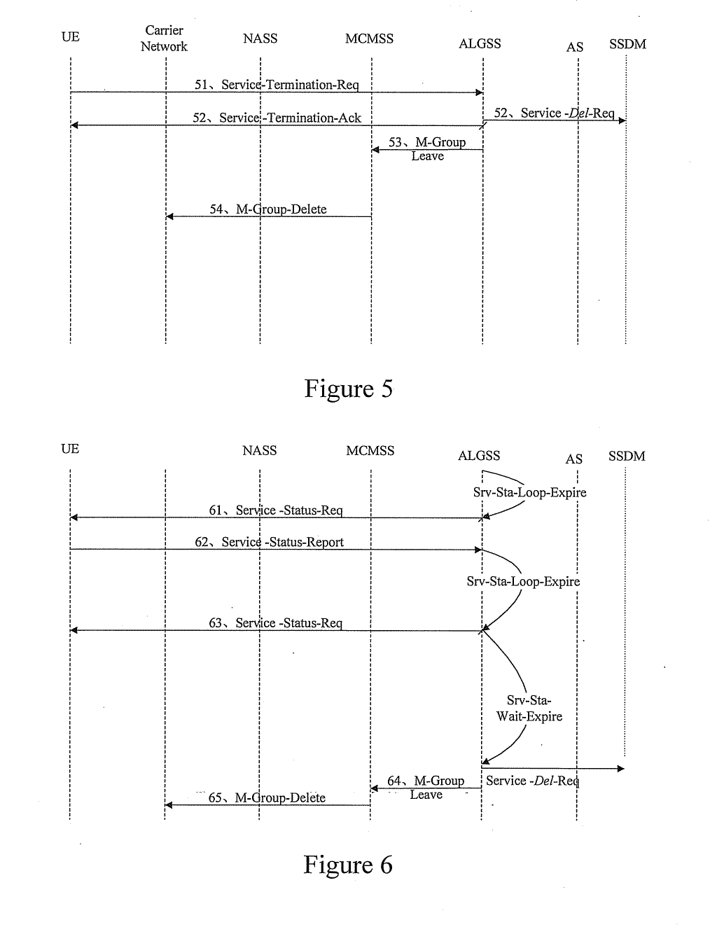

The flow chart of the multicast service termination process in accordance with an embodiment of the present invention is shown in FIG. 5 and specifically includes the steps as follows.

Step 51: a UE sends a service termination request (Service-Termination-Req), which will be forwarded to the ALGSS through a network, so as to terminate a designated multicast service.

The application layer protocol with a request and response mechanism is adopted in this step, such as the SIP, HTTP, RDP or RTSP.

Step 52: after receiving the service termination request of the user, the ALGSS handles the service termination request from the user, for example, the ALGSS checks the validity of the user; the ALGSS responds the service termination request from the user and sends a service termination announcement to an AS and/or an SSDM according to policies configured locally.

Step 53: the ALGSS instructs the MCMSS to delete the corresponding multicast paths.

It should be noted that in Steps 52 and 53, the ALGSS needs to perform a protocol conversion and send the converted message to the AS or the SSDM, if the protocols adopted by the ALGSS is different from that adopted by the AS or the SSDM.

Step 54: after receiving the instruction from the ALGSS for deleting the multicast group, the MCMSS deletes the corresponding multicast paths, releases the corresponding resources according to the multicast group member relation, and updates the multicast group member relation, that is, deletes the user from the multicast group.

In addition, to make it convenient for the network side to know in real time whether a UE is online and thus make it convenient for the network side to perform the corresponding handling, such as multicast service management and charging management, the embodiment of the present invention also provides a Keep Alive mechanism for the multicast service. The corresponding flow chart is shown in FIG. 6 and specifically includes the steps as follows.

Step 61: when a query timer in the ALGSS expires, the ALGSS sends a service state query request to a user, and starts a query wait timer and stops the query timer.

The timing duration of the query timer is the interval at which the ALGSS sends the service state query request to a user, and it may be monitored that the user is online or offline by periodically sending the service state query request, and thus an online condition of the user may be monitored.

The timing duration of the query wait timer is the duration when ALGSS monitoring the online condition of the user, that is, the maximum duration for which the ALGSS has waited for a service state report returned by the UE after the ALGSS sends the service state query request.

Step 62: after receiving the service state query request, the UE responds with the service state report if the multicast service is still online, and the ALGSS stops the query wait timer and starts the query timer after receiving the service state report returned by the UE.

Step 63: when the query timer in the ALGSS expires again, the ALGSS still sends the service state query request to the user, and starts the query wait timer and stops the query timer. The corresponding handling is the same as that in Step 61.

Step 64: when the query wait timer expires, that is, the ALGSS does not receive the service state report of the UE within the timing duration, it may be determined that the UE of the multicast service has been offline, and in this case, the ALGSS needs to perform the offline handling of the UE, such as cleaning up related data record, and request the MCMSS to delete the multicast group; and the ALGSS may also sends a service offline announcement to an AS and/or an SSDM based on a predetermined policy.

Step 65: after receiving a message from the ALGSS to request deleting the multicast group, the MCMSS deletes a multicast path and releases resources according to a multicast group member relation, and updates the multicast group member relation according to the above handling result.

The ALGSS in the system in accordance with the embodiments of the present invention may include at least one ALGF, and addressing may be performed with addressing methods between the ALGFs, such as proxy and redirection. Likewise, the MCMSS may also include at least one MCMF, and addressing may also be performed with addressing methods between the MCMFs, such as proxy and redirection. In this case, the multicast service handling processes, such as multicast service application process and a multicast service termination process, are implemented based on the corresponding ALGFs and MCMFs.

The multicast service application process and the multicast service termination process in the embodiments of the present invention are hereinafter described by taking a specific system as an example. It is supposed that in the specified system, the ALGSS is composed of one ALGF, the MCMSS is composed of multiple MCMFs provided in different network devices or apparatuses, and the MCMSS manages multicast members, multicast paths using the simple IGMP; in the system, the ANs, such as the Digital Subscriber Line Access Multiplexer (DSLAM) and the Multiple Service Access Node (MSAN) that are most neighbouring to the user, function as interfaces between the MCMSS and the ALGSS, and have the functions of managing the MCMF multicast members, calculating and configuring multicast paths; the MCMFs are distributed in various network devices in the bearer network, such as a Local Area Network Switch (LANSWITCH) with the IGMP PROXY function and a ROUTER with a Protocol Independent Multicast (PIM) routing function.

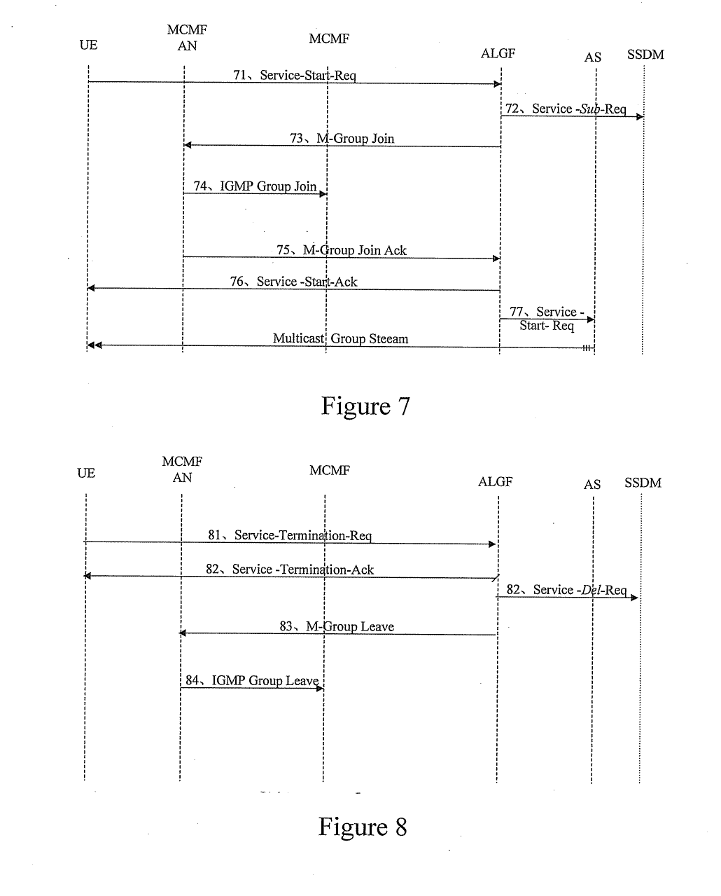

The implementation of a multicast service application process in the above specific system is shown in FIG. 7 and includes the steps as follows.

Step 71: a UE sends a multicast service start request message, for example, Service-Start-Req message, to apply for a designated multicast service.

A specific application layer protocol with a request and response mechanism is adopted in this step, such as the SIP, HTTP, RDP or RTSP.

The Service-Start-Req message will be forwarded to the ALGF via an AN.

Step 72: after receiving a multicast service application, that is, the Service-Start-Req message, sent by the user, the ALGF handles the multicast service application, and initiates the handling such as remote authorization, for example, the ALGF performs the handling of the multicast service application from the user, such as authentication.

Specifically, this step includes that the ALGSS performs the local handling of the multicast service application according to policies configured currently first, and performs the handling of the multicast service application according to the policies configured currently, such as, remote authorization. In the remote authorization, an authorization system may be chosen according to a practical policy, that is, the corresponding authorization system may be selected according to a predetermined handling policy, for example, authorization is performed in an SSDM authorization system or in an AS authorization system.

Step 73: the ALGF informs the MCMF of the request for joining the multicast group, that is, the ALGF sends a multicast group joining request to the MCMF, after the handling of the multicast service application by the ALGF.

The MCMF is located in the AN connected to the user, that is, the function of the MCMF is integrated into the AN.

Step 74: after receiving the multicast group joining request from the ALGF, the MCMF converts the protocol of the multicast group joining request into the standard IGMP or other protocols adopted by the other MCMFs in the subsequent multicast service handling process, determines, according to a multicast group member relation table and policy characteristics of multicast path, whether an IGMP notification message is to be sent, and updates the multicast group member relation table, that is, adding the user to the multicast group member relation table, so as to enable the user to perform the multicast service. The policy characteristics include management and control of message congestion.

It should be noted that the corresponding protocol conversion in this step does not need to be performed if the communication between the MCMF and the ALGF is performed by using the IGMP.

Step 75: after handling the multicast group joining request, the MCMF still responds to the ALGSS (that is, the ALGF) with a multicast group joining acknowledgement, the contents of which include the result of operations and the number of multicast group members.

Step 76: the ALGF responds to the UE with an application acknowledgement message after receiving the multicast group joining acknowledgement responded by the MCMF.

In this step, a Keep Alive mechanism of the multicast service is started in the ALGF if the application for the multicast service succeeds. With reference to the above description, the detailed process of handling the Keep Alive mechanism will not be described herein.

Step 77: the ALGF optionally sends a service issuing application request to the AS according to local policies and the multicast group member relation table so as to make the AS issue the multicast service after receiving the service issuing application request.

If the ALGF detects that the multicast service has been issued by the AS and may be sent to the user having applied for the multicast service through the multicast path, this step does not need to be performed.

The multicast service termination process in the above specific system is shown in FIG. 8 and includes the steps as follows.

Step 81: a UE sends a multicast service termination request, that is, Service-Termination-Req message, which will be forwarded to an ALGF via an AN, so as to terminate a designated multicast service.

Likewise, a specific application layer protocol with a request and response mechanism is adopted in this step, such as the SIP, HTTP, RDP or RTSP.

Step 82: after receiving the multicast service termination request from the user, that is, the Service-Termination-Req message, the ALGF handles the service termination request from the user, for example, the ALGF checks the validity of the user, then the ALGF responds the service termination request from the user, and the ALGF may send a service termination announcement to an AS and/or an SSDM according to policies configured currently to inform the AS and/or the SSDM of the information indicating the termination of the multicast service of the user so as to enable the AS and/or the SSM to flexibly manage the multicast service performed by the user according to the information.

Step 83: after tie handling of the multicast service termination request from the user by the ALGF, the ALGF instructs the MCMF to delete the multicast group to make the network side stop transferring the multicast service to the user.

Step 84: after receiving the instruction from the ALGF for deleting the multicast group, the MCMF performs a protocol conversion of the instruction through which the ALGF instructs the MCMF to delete the multicast group, thus converts the instruction into a standard IGMP message, determines, according to the multicast group member relation table and policy characteristics of multicast paths, whether an IGMP LEAVE message is to be sent, for example, determines to send the IGMP LEAVE message if the UE is the last member of the multicast group, deletes multicast paths and releases resources according to the multicast group member relation, and updates the multicast group member relation.

Likewise, the protocol conversion in this step does not need to be performed if the communication between the MCMF and the ALGF is performed by using the IGMP.

To sum up, in the embodiments of the present invention, the security of an operator network may be improved greatly because a multicast management protocol, such as the IGMP and the MLD protocol, which is run between an operator network and a user (that is, a UE or a host), is replaced with a unified application layer protocol, and the message interaction between the user (that is, the UE or the host) and the ALGSS may be performed by means of encryption, thereby increasing the security of an operator network.

Moreover, in the embodiments of the present invention, because the ALGSS and the MCMSS manage the detailed information of the multicast service of a user, which is equivalent to that there are one-to-one connections between the ALGSS and the user, and between the MCMSS and the user, the ALGSS and the MCMSS are enabled to perform online monitoring and tracing of the user, and thus various flexible charging of a multicast service is possible.

The foregoing is only preferred embodiments of the present invention. The protection scope of the present invention, however, is not limited to the above description. Any change or substitution, within the technical scope disclosed by the present invention, easily occurring to those skilled in the art should be covered by the protection scope of the present invention. Therefore, the protection scope of the present invention should be according to the claims.

1. A system for providing a multicast service, comprising:
a User Equipment (UE);
an application server (AS), for providing the UE with the multicast service;
an Application Layer Gateway Subsystem (ALGSS), for handling an application layer protocol message communicated between the network side and the UE;
a Multicast Carrier Management Subsystem (MCMSS) provided at the network side, for configuring and managing, under a triggering of the ALGSS, multicast paths through which the multicast service issued by the AS is transferred to the UE.

2. The system of claim 1, further comprising:
a service subscription management entity communicated with the ALGSS, for managing service subscription data, authorizing, according to the service subscription data, the multicast service of the UE requesting joining a multicast group under a triggering of the ALGSS, and informing the ALGSS of information that the authorization of the multicast service of the UE is passed; wherein the ALGSS triggers the MCMSS after the authorization of the multicast service of the UE by the service subscription management entity is passed.

3. The system of claim 1, further comprising:
an authentication, authorization, and/or accounting server communicated with the ALGSS, for performing at least one of access authentication, access authorization and service charging of the UE accessing to the network.

4. The system of claim 1, wherein the ALGSS further communicates with the application server, and instructs the application server to issue or stop the multicast service.

5. The system of claims 1, wherein the ALGSS comprises:
at least one application layer gateway functionality set in an access node device or at the network side, for cooperating with each other to handle the application layer protocol message communicated between the network side and the UE.

6. The system of claims 1, wherein the MCMSS comprises:
at least one multicast transport management functionality set in at least one network device or at the network side, for configuring and managing the multicast paths.

7. The system of claims 1; wherein the ALGSS is further used for managing the state of the multicast service between the ALGSS and the UE by means of a Keep Alive mechanism.

8. An application layer gateway functionality, comprising:
a multicast service handling unit, for handling an application layer protocol message communicated between the network side and a User Equipment (UE) in a process of performing a multicast service; and
a multicast service triggering unit, for triggering the configuration and management of multicast paths according to a result of the handling of the application layer protocol message.

9. The application layer gateway functionality of claims 8, further comprising:
a service query unit, for sending to the UE a service state query request for monitoring whether the UE is online;
a query timer, for managing the service query unit to periodically perform message interaction with the UE for monitoring whether the UE is online;
a query wait timer, for determining that the UE is offline when the query wait timer expires, and triggering multicast group termination handling and UE offline handling; wherein
the query wait timer is started when the application layer gateway functionality sends to the UE a message for monitoring whether the UE is online;
the query wait timer is stopped when the application layer gateway functionality receives a response message returned by the UE.

10. A multicast transport management functionality, comprising:
a topology management unit, for managing information of network topology; and
a path configuration and management unit, for configuring and managing multicast paths, according to the information of network topology, under a triggering of an application layer gateway functionality which handles an application layer protocol message communicated between the network side and a User Equipment (UE).

11. The multicast transport management functionality of claim 10, further comprising:
a protocol conversion unit, for converting a protocol sent by the application layer gateway functionality into a multicast management protocol.

12. A method for providing a multicast service, comprising:
sending, by a User Equipment (UE), to an Application Layer Gateway Subsystem (ALGSS) an application layer protocol message for providing the multicast service;
triggering, by the ALGSS, upon receiving the application layer protocol message, a Multicast Carrier Management Subsystem (MCMSS) to configure and manage multicast paths.

13. The method of claim 12, wherein the application layer protocol message comprises: a Session Initiation Protocol (SIP) message, a Real-Time Stream Protocol (RTSP) message, a Hypertext Transfer Protocol (HTTP) message and a Remote Desktop Protocol (RDP) message.

14. The method of claim 12, further comprising:
instructing, by the ALGSS, based on a configured policy, an application server of the multicast service to issue or stop the multicast service.

15. The method of claim 12, further comprising:
authorizing, by a service subscription data management entity, the multicast service of the UE requesting joining a multicast group under a triggering of the ALGSS.

16. The method of claim 12, further comprising:
performing, by an authentication, authorization and/or accounting server, at least one of access authentication, access authorization and service charging of the UE accessing the network.

17. The method of claim 12, wherein the application layer protocol message comprises a multicast service request/termination message of application layer; and
the triggering the MCMSS to configure and manage the multicast paths comprises:
instructing the MCMSS to configure and manage or delete the multicast paths.

18. The method of claim 17, further comprising:
converting, by the MCMSS, an instruction received from the ALGSS into a multicast management protocol message.

19. The method of claim 17, further comprising:
periodically performing, by the ALGSS, message interaction with the UE, and monitoring, according to a result of the message interaction, whether the UE is online.

20. The method of claim 17, wherein the configuring and managing the multicast paths further comprises:
handling a Connection Admission Control (CAC) of the multicast paths; and
managing an allocation and callback of network resources; wherein
the CAC is used for determining whether remaining resources in the bearer network meet demands of the Quality of Service (QoS) of the multicast paths to be established.
